(19) United States
(12) Patent Application Publication
(10) Pub. No.: US 2003/0023694 A1
(43) Pub. Date: Jan. 30, 2003

(54) Portable electronic mail messaging device

(76) Inventor: James Macor, Jackson, NJ (US)

Correspondence Address: BIRCH STEWART KOLASCH & BIRCH, PO BOX 747, FALLS CHURCH, VA, 22040-0747, US

(21) Appl. No.: 10/131,094

(22) Filed: Apr. 25, 2002

Related U.S. Application Data
(63) Continuation-in-part of application No. 09/061,682, filed on Apr. 16, 1998.

(51) Int. Cl. G06F 15/16

(52) U.S. Cl. 709/206; 709/245

(57) ABSTRACT

A communication system and method for operating a communication system relate to the forwarding of email messages from a person's home or office workstation, e.g. personal computer, to a wireless portable device. The wireless portable device is carried by the person while within in the local vicinity of the workstation, such as up to one mile away. Email messages received by the workstation are forwarded from the workstation directly to the wireless portable device, so that a person expecting an important email message can roam away from the workstation.

### TECHNICAL FIELD OF THE INVENTION

The present invention relates generally to portable messaging devices, and more particularly to a portable messaging device capable of receiving voice mail and electronic mail.

### BACKGROUND OF THE INVENTION

As the prevalence of electronic mail (“e-mail”) and voice mail systems increases, people feel a growing need to retrieve a message virtually as soon as it arrives. In the business environment, there are many reasons for people to have immediate access to email messages.

Often a person at home or at work is expecting an important email message and knows that an immediate response is required. For example, a business transaction is occurring over a period of hours and you may be called upon at any time, via email, to quickly answer a question. That person must remain either at their computer, or at least return to their computer every few minutes to see if a message has arrived. This is stressful and wastes time.

One solution would be to purchase a portable laptop computer and purchase a wireless peripheral device which would allow the laptop to receive messages. People could address important emails to your laptop computer, or you have all emails automatically forwarded from your primary computer to your laptop computer. However, this is an expensive solution. A laptop computer, in effect, simply duplicates the functionality of the primary home or office computer. Further, you are no longer “tied” to your primary computer, but you have to carry around a heavy laptop computer.

### SUMMARY OF THE INVENTION

Applicant has appreciated a need in the art for a solution to the drawbacks of the background art, and it is an object of the present invention to address one or more of the drawbacks of the background art.

It is an object of the present invention to provide a communication system wherein a primary computer or workstation is capable of relaying information regarding incoming messages at radio frequencies to a wireless portable device. By this arrangement, a user in the vicinity of the workstation could receive messages on a wireless portable device, which is small and inexpensive relative to a laptop computer. In other words, the user could receive text or voice messages, collectively referred to as messages or email messages without having direct physical access to a workstation.

It is an object of the present invention to provide a peripheral device for attachment to a workstation in combination with a small, inexpensive device that can receive information about messages received at the workstation via the peripheral device.

In is an object of the present invention to provide a method of operating a communication system for relaying information about messages received at a workstation to a wireless portable device carried by a user.

In the present invention, a user's workstation, which may be a personal computer for example, receives an incoming e-mail message over a computer network in communication with the workstation, such as the internet. The workstation, in turn, transmits a radio signal from the workstation to a wireless portable device. The radio signal includes information about the message, such as the sender's name, the subject header, the date and time of the email, and/or the text, sounds or graphics of the message.

The wireless portable device receiving the electronic mail includes a wireless receiver for receiving the radio signal from the workstation and a display for displaying the information about the message. The wireless portable device could also include a processor and a memory for processing and storing the messages.

The wireless portable device may also include an ability to receive a user's input command, and transmit this command back to the workstation.

In an alternative embodiment of the invention, a service provider such as a cellular telephone provider, for example, first receives the electronic mail. The electronic mail is intended for a subscriber of the service provider. The service provider in turn transmits the electronic mail to the subscriber's workstation and a portable device in the possession of the subscriber.

Other objects and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 shows one embodiment of the wireless portable device, constructed in accordance with the present invention, receiving electronic messages from a workstation;

FIG. 2 shows a simplified block diagram of the workstation, shown in FIG. 1;

FIG. 3 shows a simplified block diagram of the wireless portable device shown in FIG. 1;

FIG. 4 is a flowchart showing the steps performed by the workstation shown in FIG. 1;

FIG. 5 shows an alternative embodiment of the invention in which electronic messages are received by a service provider and forwarded to the wireless portable device; and

FIG. 6 is a flowchart showing the steps performed by the service provider shown in FIG. 5.

### DETAILED DESCRIPTION

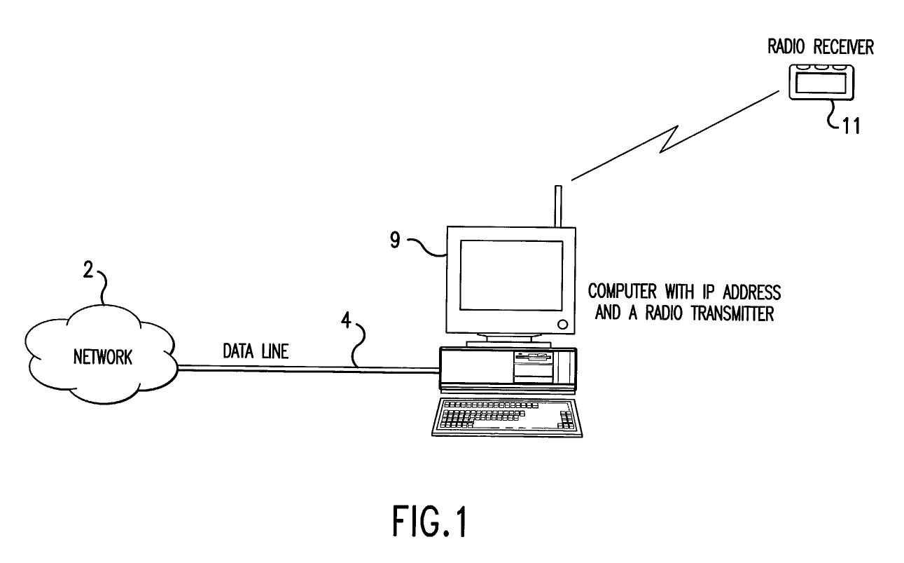

In accordance with the present invention as shown in FIG. 1, a workstation 9 for receiving electronic-mail messages is equipped with a wireless transmitter for transmitting information about a received e-mail to a wireless portable device 11. The wireless portable device 11 may be conveniently carried on the user's person in a pocket or wallet, for example.

In one embodiment of the invention, the workstation 9 is a personal computer connected over a data line 4 to a network 2, such as a local area network or the internet. Such a personal computer would often include a keyboard, a mouse, speakers, a microphone, a video display, a joystick, and a component case housing a processor and memory and housing other peripheral devices such as a removable disc reader/writer, a compact disc reader/writer, a DVD reader/writer, a zip drive, etc.

Some workstations have limited capabilities, such as a computer device dedicated to exploring the internet and working with email. Another example, is a workstation dedicated to video gaming and working with email.

For purposes of this application, a “workstation” is intended to mean any computer device where a person may access their email, and perform such functions as viewing email, listening to email, deleting email, forwarding or responding to email, and/or composing new emails, regardless of whether the workstation offers additional features, such as video gaming, word processing, etc.

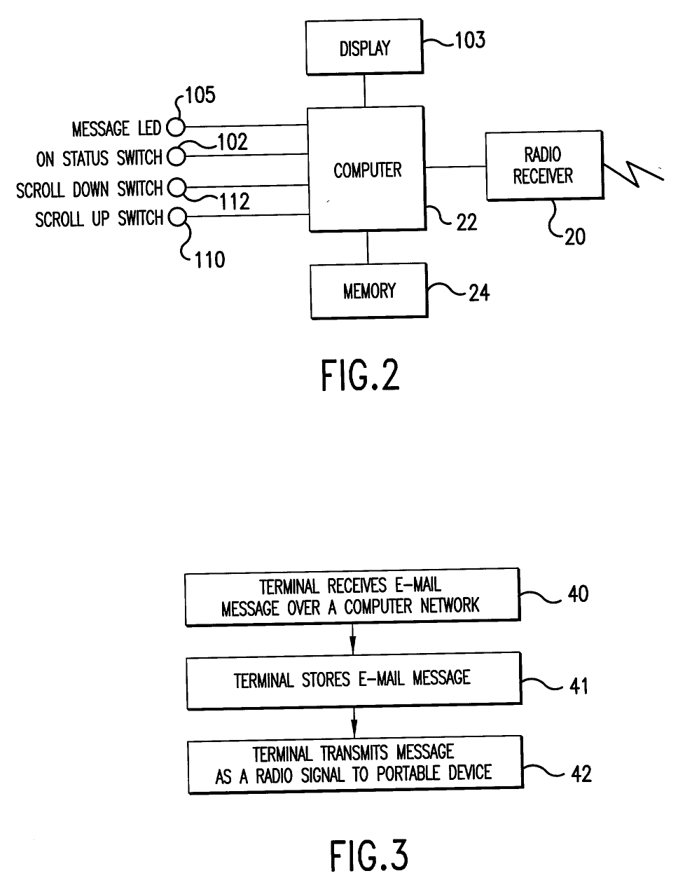

As shown in more detail in FIG. 2, the workstation 9 contains a processor 66, a local storage device 62, and a display 58. A first wireless unit, such as a wireless transmitter 64 is controlled by the processor 66. In one embodiment, the wireless transmitter 64 is a radio frequency circuit board and antenna 56 integrated into the workstation 9. In an alternate embodiment, the wireless transmitter 64 is connected to the workstation 9 via an expansion slot of the workstation 9. In still a further embodiment, the wireless transmitter includes its own housing separate from the workstation 9 and is connected to the workstation 9 via a cable or wireless connection to a port of the workstation 9.

The wireless transmitter 64 operates in accordance with known wireless technology, such as employed in a cordless telephone base station. For example, the wireless transmitter 64 can generate frequency modulated (FM) channels assigned to the wireless portable device 11, such as in the

800-900 MHz range. Of course, the transmitter 64 could operate with RF signals of other wavelengths as well, such as in the two giga-hertz range.

Mail messaging protocols are resident in the workstation 9 as software. The software 60 is a commercially available mail messaging package such as QuickMAIL PRO®, which is available from CE Software. Incoming electronic messages received through the software 60 are initially stored in the local storage device 62 and subsequently directed to the wireless transmitter 64, which transmits information about the electronic messages to the wireless portable device 11 as a radio signal.

The specific information about the electronic message which is transmitted could be specified via menu options in the software 60. For example, one could select to send one or more of the following information about the electronic message: the sender's name, the subject heading, the date and time of the message, the substantive content of the message without graphics or sounds, and/or the text of the message with graphics and sounds.

The entire process is actuated by a simple software protocol that operates in accordance with the software interface instructions specific to the workstation 9. The software employs a graphical user interface icon with which the user selects from among the various menu options. Such options could also include the ability to activate and deactivate the transfer of messages to the wireless portable device 11.

FIG. 3 shows a simplified block diagram of the wireless portable device 11, constructed in accordance with the present invention for receiving a subscriber's e-mail. The wireless portable device 11 includes a second wireless unit, such as a wireless receiver 20. The wireless portable device 11 also includes a processor 22, memory 24, an electronic display 103 that extends over its housing surface and optionally a speaker for sound attachments to emails. The wireless receiver 20 receives the messages and sends them to the display 103. Alternatively or in addition, the messages are stored in memory 24.

When the messages are stored, the messages may be sorted chronologically and displayed on display 103 in the order they are received. In the default mode, the oldest unopened message in the memory 24 is displayed first. Once all the unopened mail has been displayed, any previously opened messages remaining in the memory 24 will be displayed.

Depressing push-button 102 activates the display 103. A message indicator 105 such as an LED and/or a transducer, for example, alerts the subscriber that a message has arrived by emitting light or generating an audible tone, respectively. If desired, the indicator 105 can be deactivated. It is also possible to switch between audio and visual indicating states, by any convenient means, such as by providing a small hole containing a recessed switch that is accessed by an object such as a pen.

Scroll forward and scroll backward buttons 110 and 112 may be employed, for chronologically scrolling through a series of messages that have been received. Upon activation, the device operates in a default mode in which the most current message is displayed. The wireless receiver 20 contained within the portable device is compatible with the wireless transmitter 64 controlled by the workstation 9. If cordless telephone technology is employed, the wireless receiver 20 is of the type found in a conventional cordless telephone handset, which presently offers a range of up to almost a mile.

In a preferred embodiment, the first wireless unit, controlled by the workstation 9, is a first wireless transmitter/receiver 64′, and the second wireless unit of the wireless portable device 11 is a second wireless transmitter/receiver 20′. In this embodiment, the second transmitter/receiver 20′ can transmit an acknowledgement signal back to the first transmitter/receiver 64′ to indicate that the message has been received. Further, the wireless portable device 11 can include user inputs, so that the wireless portable device 11 can allow the user to send a command or commands back to the workstation 9, such as a command to delete a message or archive a message. Of course, the software 60 resident in the workstation 9 would have an option menu to control or restrict the wireless portable device's ability to manipulate messages in the workstation.

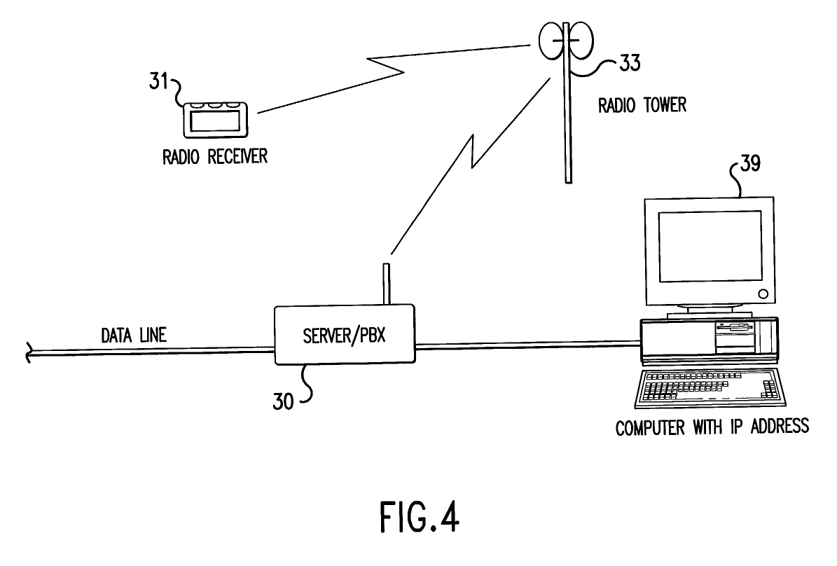

FIG. 4 shows a flowchart of the steps performed by the workstation 9. In step 40, the workstation 9 receives the e-mail message over the computer network 2 shown in FIG. 1. In step 41, the workstation 9 stores the e-mail message in its local storage device 62. Finally, in step 42, the workstation 9 transmits the message as a wireless signal to the wireless portable device 11.

In the preferred embodiment, the workstation 9 will retransmit the wireless signal at periodic intervals, until it receives confirmation from the wireless portable device 11 that the message has been received.

The present invention contemplates numerous variations to the structures and software depicted in FIGS. 2 and 3. For example, the previously-mentioned messaging protocols may be embodied in the workstation 9 as hardware, software, or a combination of both. Moreover, the transmitting method may operate in a variety of different ways. For example, instead of storing the message prior to it being transmitted to the wireless portable device 11, the message may be transmitted to the wireless portable device 11 prior to, or even in lieu of, being stored in the workstation 9.

The invention illustrated in FIGS. 1-4 offers many advantages over the state of the art. A person at home could carry the wireless portable device 11 and work in the kitchen, work in the garage, relax by the poolside, or anywhere that a typical cordless phone can operate proximate to the house. If an email is sent to the home computer, the email or at least information about the email is relayed to the wireless portable device 11. The person can review the email by sender, subject heading, or even the entire message text to discriminate whether the email is important. If the email is important, the person can return to the home computer to reply to it. By the present invention you are not “tied” to your computer if you are worried about important messages.

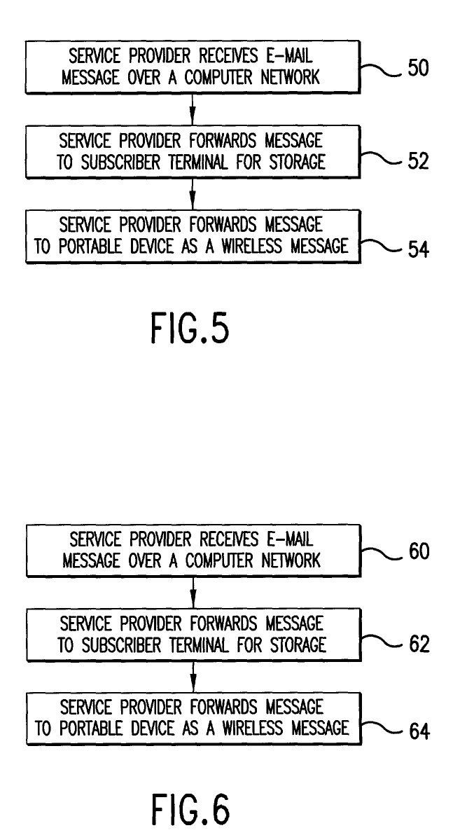

In an alternative embodiment of the invention, shown in FIG. 5, the e-mail message need not be transmitted to the wireless portable device 31 by the subscriber's workstation 39. Rather, the message may be initially directed to a server 30 of a service provider over a data line connected to a computer network 2. The service provider's server 30 in turn transmits the message to both the subscriber's workstation 39 (via a computer network) and the wireless portable device 31 (via a wireless transmission). Thus, the subscriber is not required to be in constant communication with the subscriber's workstation 39.

The service provider advantageously may be an established cellular telephone or paging provider, in which case it would be particularly convenient to employ conventional cellular or paging technologies as the wireless technologies. In this alternative embodiment of the invention, the subscriber is not even required to be in communication with the subscriber's workstation 39 at all, since the service provider performs the function otherwise performed by workstation 39. Of course, at the subscriber's option, the e-mail also may be received at the electronic address of his or her workstation 39.

FIG. 6 shows a flowchart depicting the steps performed by the service provider's server 30. In step 50, the service provider 30 receives the e-mail message over a computer network. In step 52, the service provider 30 forwards the message to the subscriber's workstation 39 for electronic storage therein. In step 54, the service provider 30 also forwards the message to the wireless portable device 31. Of course, the order in which steps 52 and 54 are performed may be reversed, or they may occur simultaneously.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A communication system comprising:
a workstation including software to allow a user to read, delete, respond to and/or compose email messages, said workstation including at least a processor and memory;
a wireless transmitter controlled by said processor of said workstation, wherein said wireless transmitter transmits a first wireless signal including information regarding an email message received by said workstation;
a wireless portable device carried by the user when in a vicinity of said workstation, said wireless portable device including a wireless receiver and a display, said wireless receiver receiving the first wireless signal including the information regarding the email message received by said workstation, and said display displaying the information regarding the email message received by said workstation.

2. The communication system according to claim 1, wherein the information regarding the email message received by said workstation includes an email sender's name.

3. The communication system according to claim 1, wherein the information regarding the email message received by said workstation includes a subject heading of the email.

4. The communication system according to claim 1, wherein the information regarding the email message received by said workstation includes a date and time of the email.

5. The communication system according to claim 1, wherein the information regarding the email message received by said workstation includes an entirety of the email message received by said workstation.

6. A communication system comprising:
a workstation including software to allow a user to read, delete, respond to and/or compose email messages, said workstation including at least a processor and memory;
a first wireless transmitter/receiver controlled by said processor of said workstation, wherein said first wireless transmitter/receiver transmits a first wireless signal including information regarding an email message received by said workstation;
a wireless portable device carried by the user when in a vicinity of said workstation, said wireless portable device including a second wireless transmitter/receiver and a display, said second wireless transmitter/receiver receiving the first wireless signal including the information regarding the email message received by said workstation, said display displaying the information regarding the email message received by said workstation, and said second wireless transmitter/receiver sending a second wireless signal for receipt by said first wireless transmitter/receiver of said workstation.

7. The communication system according to claim 6, wherein said second wireless signal includes an acknowledgement signal that said first wireless signal was received by said wireless portable device.

8. The communication system according to claim 6, wherein said wireless portable device includes at least one user input, and wherein said second wireless signal is transmitted in response to a command inputted into said wireless portable device via said at least one user input.

9. The communication system according to claim 8, wherein said second wireless signal includes a command to said workstation to delete an email message.

10. The communication system according to claim 6, wherein said first wireless transmitting/receiving device is physically located on a PC card attached to said workstation via an expansion slot of said workstation.

11. The communication system according to claim 6, wherein said first wireless transmitting/receiving device includes its own housing separate from said workstation and is connected to said workstation via a port of said workstation.

12. The communication system according to claim 6, wherein said first wireless transmitting/receiving device is integrally formed as a component part of said workstation.

13. The communication system according to claim 6, wherein the vicinity of said workstation is defined as less than approximately one mile from said workstation.

14. A communication system comprising:
a wireless transmitter for connection to a workstation including at least a processor, memory and software to allow a user to read, delete, respond to and/or compose email messages, wherein said wireless transmitter is controllable by the processor of the workstation, and wherein said wireless transmitter transmits a first wireless signal including information regarding an email message received by the workstation; and
a wireless portable device carried by the user when in a vicinity of the workstation, said wireless portable device including a wireless receiver and a display, said wireless receiver receiving the first wireless signal including the information regarding the email message received by the workstation, and said display displaying the information regarding the email message received by the workstation.

15. The communication system according to claim 14, wherein the information regarding the email message received by the workstation includes at least one of an email sender's name and a subject heading of the email.

16. The communication system according to claim 14, wherein the information regarding the email message received by the workstation includes an entirety of the email message received by the workstation.

17. The communication system according to claim 14, wherein said wireless transmitter is physically located on a printed circuit board (PCB) and said PCB is for attachment to the workstation via an expansion slot of the workstation.

18. The communication system according to claim 14, wherein said wireless transmitter includes its own housing and is connectable to the workstation via a port of the workstation.

19. A communication system comprising:
a first wireless transmitter/receiver for connection to a workstation including at least a processor, memory and software to allow a user to read, delete, respond to and/or compose email messages, wherein said first wireless transmitter/receiver is controllable by the processor of the workstation, and wherein said first wireless transmitter/receiver transmits a first wireless signal including information regarding an email message received by the workstation; and
a wireless portable device carried by the user when in a vicinity of the workstation, said wireless portable device including a second wireless transmitter/receiver and a display, said second wireless transmitter/receiver receiving the first wireless signal including the information regarding the email message received by the workstation, said display displaying the information regarding the email message received by the workstation, and said second wireless transmitter/receiver sending a second wireless signal for receipt by said first wireless transmitter/receiver of the workstation.

20. The communication system according to claim 19, wherein the information regarding the email message received by the workstation includes at least one of an email sender's name and a subject heading of the email.

21. The communication system according to claim 19, wherein the information regarding the email message received by the workstation includes an entirety of the email message received by the workstation.

22. The communication system according to claim 19, wherein said first wireless transmitting/receiving device is physically located on a printed circuit board (PCB) and said PCB is for attachment to the workstation via an expansion slot of the workstation.

23. The communication system according to claim 19, wherein said first wireless transmitting/receiving device includes its own housing and is connectable to the workstation via a port of the workstation.

24. A method of operating a communication system comprising the steps of:
providing a workstation including at least a processor, memory and software to allow a user to read, delete, respond to and/or compose email messages;
receiving an email message at the workstation;
controlling a first wireless unit connected to the workstation using the processor of the workstation;
transmitting a first wireless signal from the first wireless unit including information regarding the email message received by the workstation;
receiving the first wireless signal at a second wireless unit connected to a wireless portable device carried by the user; and
displaying the information regarding the email message received by the workstation on a display of the wireless portable device.

25. The method according to claim 24, further comprising the step of:
transmitting an acknowledgement signal from the second wireless unit to the first wireless unit indicating that the wireless portable device received the information regarding the email message received by the workstation.

26. The method according to claim 24, further comprising the steps of:
inputting a user command via at least one input on the wireless portable device; and
transmitting the user command from the second wireless unit to the first wireless unit.

27. The method according to claim 26, wherein the user command is an instruction to delete an email.
